(19) United States
(12) Patent Application Publication
(10) Pub. No.: US 2024/0123750 A1
(43) Pub. Date: Apr. 18, 2024

(54) PRINTING APPARATUS AND METHOD

(71) Applicant: Ironburg Inventions Limited, Shepshed (GB)

(72) Inventor: Carl Jeffrey, Cheltenham (GB)

(21) Appl. No.: 18/047,007

(22) Filed: Oct. 17, 2022

(51) Int. Cl. B41M 5/035; B41F 17/00

(52) U.S. Cl. CPC B41M 5/0358; B41F 17/006

(57) ABSTRACT

The invention provides apparatus for printing a three-dimensional structure, such as, but not limited to, a games console and to a method of sublimation printing. The apparatus comprises a tray having at least one mounting location for receiving a jig. The jig is configured to form a rigid frame or body for an article. The jig is formed from a material capable of withstanding the temperature of a sublimation print process without substantial deformation or distortion. The jig is configured to mate with the article so as to retain the shape of the article during the sublimation print process and the jig is removably mountable to the mounting location of the tray.

### FIELD

The present invention relates to an apparatus for printing a three-dimensional structure, such as, but not limited to, a games console and to a method of sublimation printing, and more particularly, but not exclusively the invention relates to, a jig for retaining the three-dimensional structure in a sublimation printer device.

### BACKGROUND

Dye sublimation printing requires heating a sublimation ink on a special paper to a sufficiently high temperature, and may be up 200° C., such that the ink changes state from a solid to a gas and is able to enter the pores of the substrate of the item being printed. The item is cooled, the pores close, leaving the ink and/or image trapped on the item's surface.

The substrate of the item being printed needs to be able to withstand the temperatures of the printing process, which can present a problem when printing some materials including plastics, leather, wood, or glass items.

The heat employed in the sublimation process can cause plastic items to melt or warp, effectively destroying the item.

An object of the present invention is to provide an apparatus for dye sublimation printing of a shaped or contoured plastic item, which may have a formed or non-planar shape, and to retain the shape of the plastic item, preventing, inhibiting or minimizing deformation of the item after printing.

The present invention seeks to overcome or at least mitigate the problems of the prior art.

### SUMMARY

A first aspect of the present disclosure provides a jig for use in a sublimation print device comprising a rigid frame or body for receiving an article. The jig is formed from a thermally conductive material capable of withstanding the temperature of a sublimation print process without substantial deformation or distortion. The material may be thermally conductive. The jig is configured to mate with an article so as to retain the shape of the article during the sublimation print process. The jig is removably mountable to a mounting location of the tray.

Advantageously, the jig prevents or reduces distortion or deformation of the article when heated during the printing process.

Optionally, the jig comprises at least one first registration device for engagement with the article.

Optionally, the jig comprises at least one detachable member.

Optionally, the at least one detachable member is configured to close at least a portion of an opening in the article.

Optionally, the jig comprises receiving location for mounting two or more component parts of an article, the jig holding the two or more component parts in the same respective positions as the article which they form.

A second aspect of the present disclosure provides a tray for use in a sublimation print device. The tray comprises at least one mounting location for receiving a jig. The jig is configured to be detachable mountable to the tray. The at least one mounting location is recessed in an upper surface of the tray.

Optionally, the tray comprises a concave upper surface, and the mounting locations are arranged such that the jig and article, when mounted thereto, are disposed below an upper periphery of the tray.

Optionally, the tray comprises at least one registration device for engagement with the article.

Optionally, the tray comprises at least one registration device for engagement with the jig.

Optionally, the tray comprises a release device including a cut-out in the tray for insertion of a release tool.

Optionally, the tray comprises a plurality of openings in the upper surface of the tray for creating a vacuum.

A third aspect of the present disclosure provides an apparatus for use in a sublimation print device. The apparatus comprises a tray having at least one mounting location for receiving a jig. The jig is configured to form a rigid frame or body for an article. The jig is formed from a material capable of withstanding the temperature of a sublimation print process without substantial deformation or distortion. The jig is configured to mate with the article so as to retain the shape of the article during the sublimation print process and the jig is removably mountable to the mounting location of the tray.

Optionally, the jig comprises at least one first registration device for engagement with at least one second registration device provided by the article.

Optionally, the tray comprises at least one third registration device for engagement with the at least one second registration device provided by the article.

Optionally, the tray comprises at least one alignment device for engagement with an alignment device provided by the jig.

Optionally, the tray comprises a release device for facilitating separation of the jig from the tray.

Optionally, the release device comprises a cut-out in at least one of the tray and the jig for insertion of a release tool.

Optionally, the mounting location comprises a recess in an upper surface of the tray for receiving at least a portion of the jig.

Optionally, the jig comprises at least one detachable member.

Optionally, the at least one detachable member is configured to close at least a portion of an opening in the article.

Optionally, the jig comprises receiving location for mounting two or more component parts of an article, the jig holding the two or more component parts in the same respective positions as the article which they form.

Optionally, the tray comprises a concave upper surface, and the mounting locations are arranged such that the jig and article are disposed below an upper periphery of the tray.

A fourth aspect of the present disclosure provides a method of sublimation printing an article comprising:
mounting the article to a jig;
mounting the combination of the jig and the article to a tray;
applying a sublimation print sheet to the tray over the jig and the article;
inserting the tray into a print device;
heating the sublimation print sheet, tray, jig and article sufficient to sublimate ink on the sublimation print sheet;
transferring ink on the sublimation print sheet to the article;
removing the tray from the print device;
removing the combination of the article and the jig from the tray;
cooling the article and the jig; and
removing the article from the jig.

Optionally, the method further comprises aligning the article with the jig and aligning the jig and/or article with respect to the tray.

Within the scope of this application, it is envisaged or intended that the various aspects, embodiments, examples, features and alternatives set out in the preceding paragraphs, in the claims and/or in the following description and drawings may be considered or taken independently or in any combination thereof.

Features or elements described in connection with, or relation to, one embodiment are applicable to all embodiments unless there is an incompatibility of features. One or more features or elements from one embodiment may be incorporated into, or combined with, any of the other embodiments disclosed herein, said features or elements extracted from said one embodiment may be included in addition to, or in replacement of one or more features or elements of said other embodiment.

A feature, or combination of features, of an embodiment disclosed herein may be extracted in isolation from other features of that embodiment. Alternatively, a feature, or combination of features, of an embodiment may be omitted from that embodiment.

Further features and advantages of the present invention will be apparent from the specific embodiments illustrated in the drawings and discussed below.

### BRIEF DESCRIPTION OF THE DRAWINGS

Exemplary embodiments of the invention will now be described with reference to the accompanying drawings, in which:

FIG. 1A shows a component, generally from above, for forming a games console controller according to an embodiment of the present disclosure, the component is an item to be printed;

FIGS. 1B and 2 show a jig, generally from above, for receiving the component of FIG. 1A during a printing operation;

FIG. 3A shows the jig of FIG. 1B in which portion of the jig have been removed or detached;

FIGS. 3B and 3C show portions removed from the jig shown in FIG. 3A;

FIG. 4A shows the jig of FIG. 1B from below;

FIG. 4B shows the component, of FIG. 1A from below;

FIG. 5A is a plan view from above of the jig of FIG. 1B;

FIG. 5B is an end view of the bottom of the jig of FIG. 1B;

FIG. 5C is a side view of a first side of the jig of FIG. 1B;

FIGS. 6A, 6B, and 6C show various perspective views of the component of FIG. 1A mounted to the jig of FIG. 1B;

FIG. 7 is a plan view from above of a tray for receiving the jig of FIG. 1B; and

FIGS. 8 and 9 show various perspective views of the tray of FIG. 7.

### DETAILED DESCRIPTION

Detailed descriptions of specific embodiments of printing apparatus, a component holding jig, printing tray, and a printing method are disclosed herein. It will be understood that the disclosed embodiments are merely examples of the way in which certain aspects of the disclosed adapter can be implemented and do not represent an exhaustive list of all of the ways the adapter may be embodied. As used herein, the word “exemplary” is used expansively to refer to embodiments that serve as illustrations, specimens, models, or patterns. Indeed, it will be understood that the printing apparatus, a component holding jig, printing tray, and a printing method described herein may be embodied in various and alternative forms. The Figures are not necessarily to scale and some features may be exaggerated or minimized to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

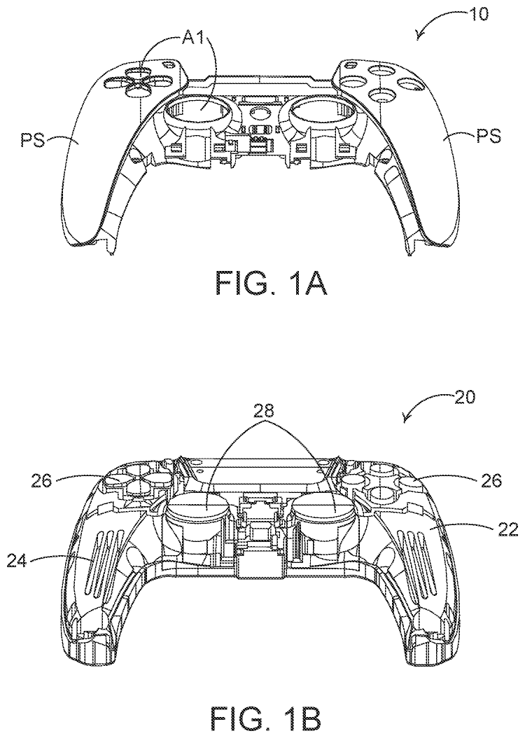

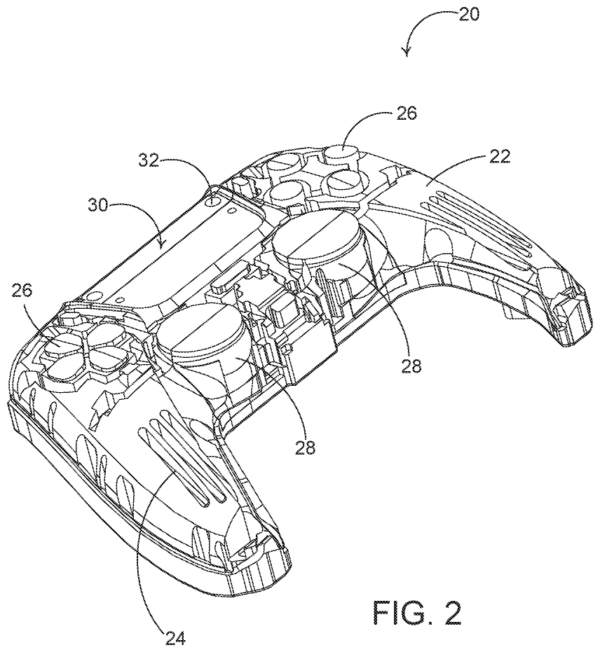

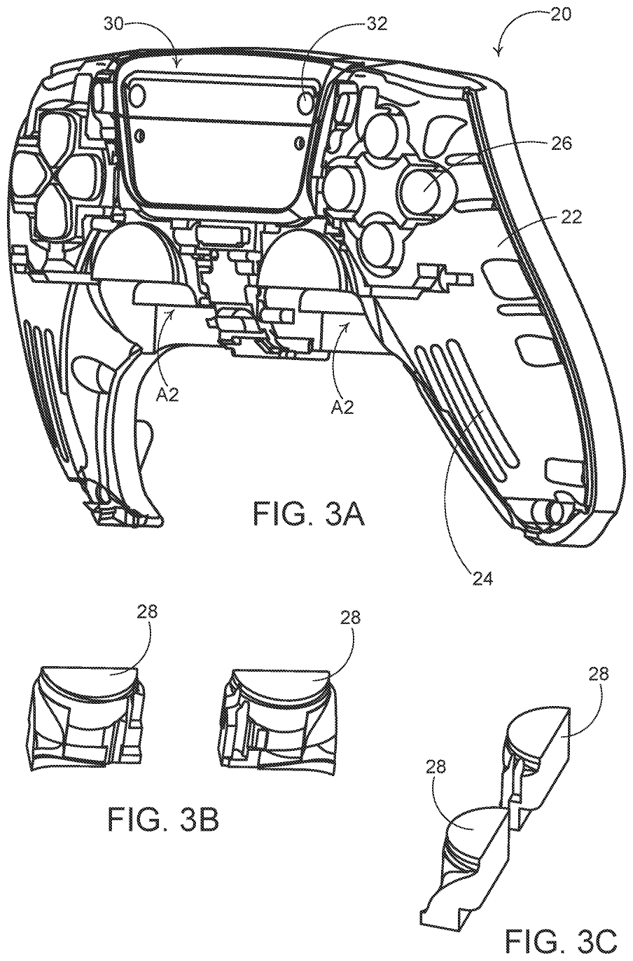

Referring to FIG. 1A there is shown a component 10 of a game controller input apparatus for a use with a computer. The input apparatus takes the form of a game pad for use with a video games console, personal computer, laptop computer, mobile device, cloud gaming system, or similar. In other embodiments, the input apparatus may take the form of a handheld games console or other mobile device such as but not limited to a smartphone, tablet computer, phablet or the input apparatus may be, or may be incorporated into, an accessory device (such as, but not limited to, a sleeve or case) for use with such a mobile device.

The component 10 is an item or article upon which it is desired to print indicia, information or an image. The component is formed from a plastics material and may have been formed using a plastics molding technique such as injection molding, 3D printing or other suitable method. The component 10 comprises at least one surface upon which it is desired to print, said at least one surface may form an external surface PS of the controller input apparatus and may be nonplanar in shape, the at least one surface may be curved or contoured. The component 10 may comprise one or more openings A1 for receiving portions of the controller apparatus such as but not limited to electrical connectors or ports, display devices such as screens or lights, fixing devices such as screws, input controls in the form of switches, buttons, touch pads, directional pads, analogue thumb sticks or motion pots.

FIG. 1B shows a jig 20 for receiving the component 10. The jig 20 is shaped complementary to the component 10 and is receivable in an inner surface of the component 10. The inner surface is hidden from view in normal use of the controller input apparatus and is an unprinted surface.

The jig 20 comprises one or more registration devices, the registration devices may take the form of openings or orifices 24, A3 in a body or frame 22 of the jig 10. The registration devices may take the form of lugs, pegs or projections 26 extending from the body or frame 22 of the jig 10.

The jig 20 may be configured to form a close fit within the component 10 preventing distortion of deformation of the component 10, in particular when heated during the printing process.

The registration devices may be received in openings A1 of the component 10 and may blank off, or close, the openings A1.

The component 10 may comprises one or more registration devices in the form of posts or pegs 23, the posts 23 may be received in the openings A3 in the body 22 of the jig 10.

The jig 20 may comprise one or more detachable or removable portions 28, each of the one or more removable portions 28 may at least partially close an opening A1 in the component 10. The removable portions 28 may be advantageous when fitting the component 10 to the jig 20, in particular where undercuts are required.

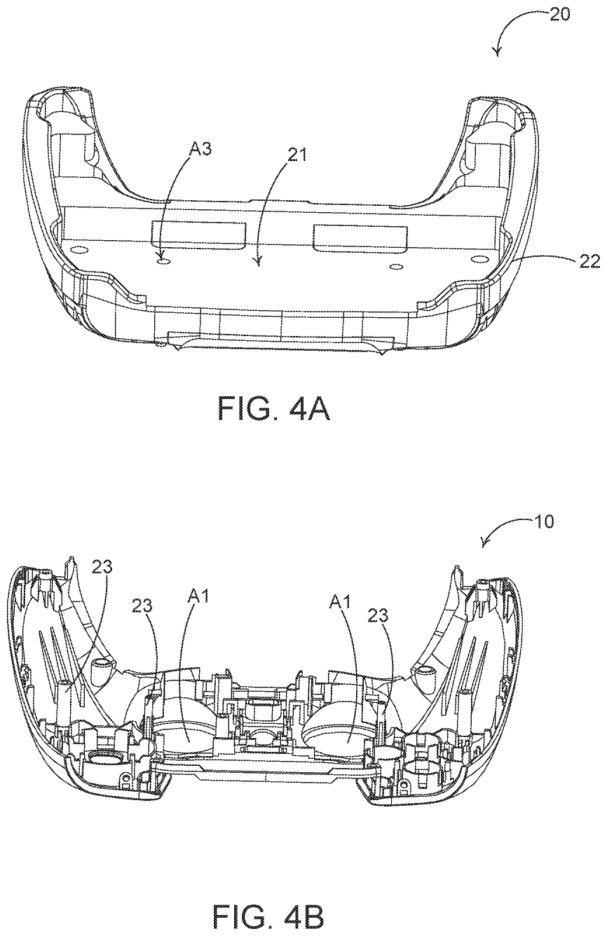

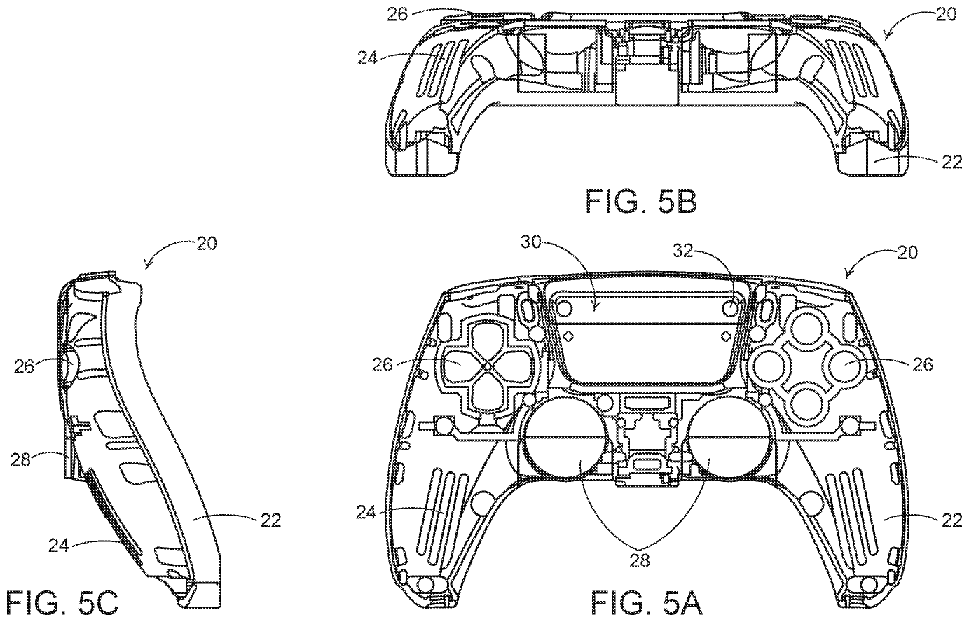

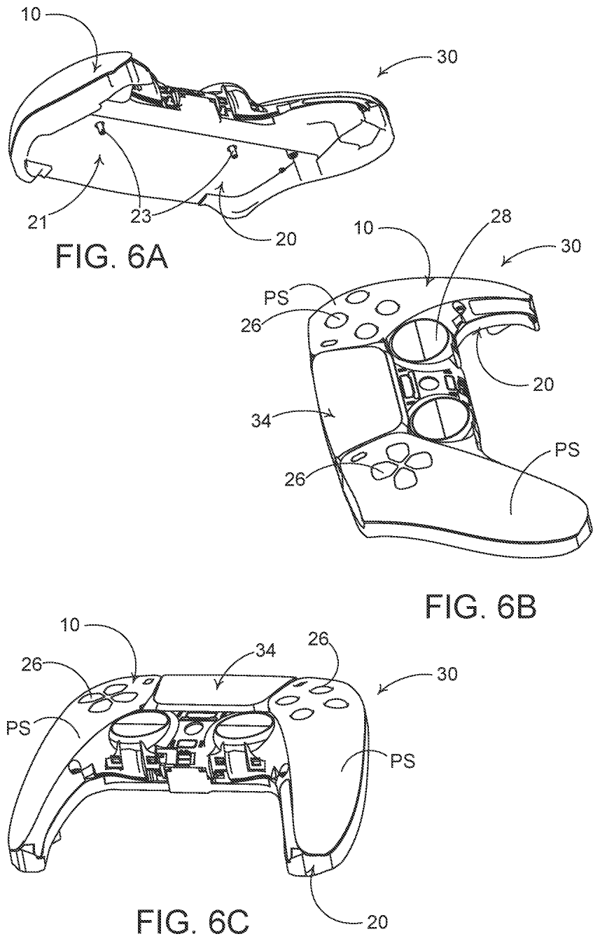

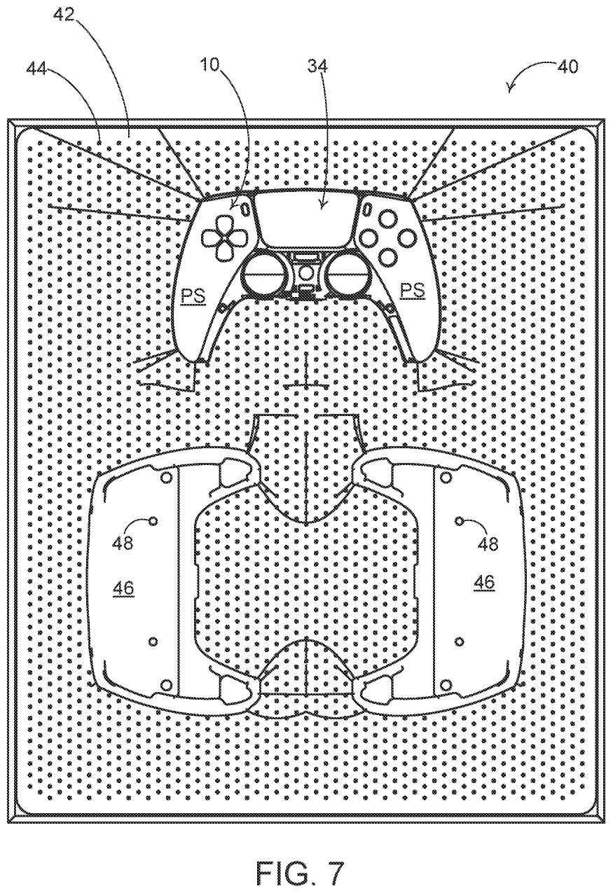

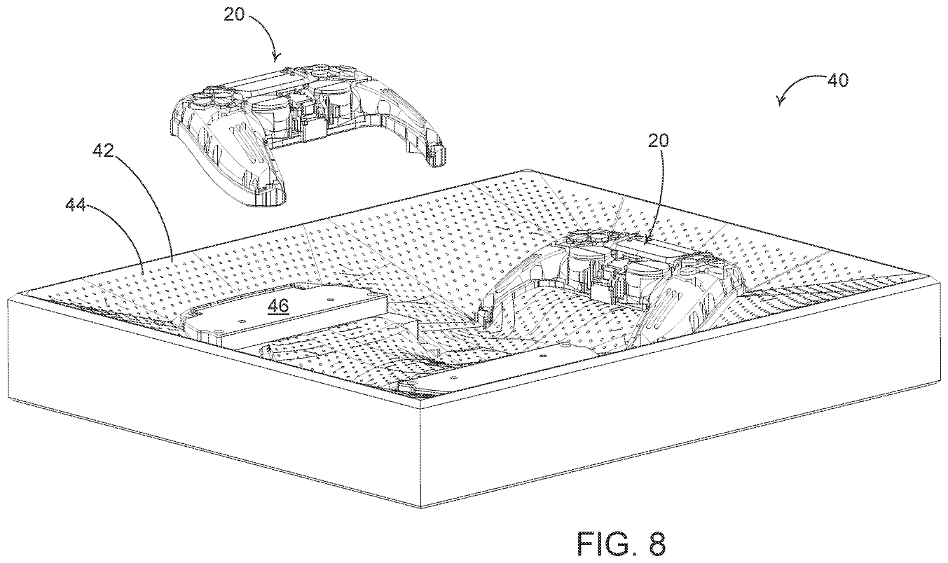

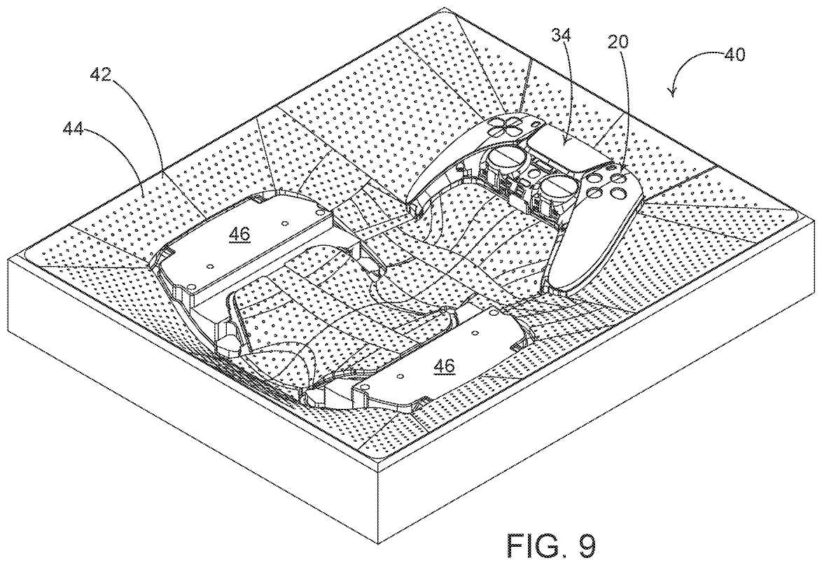

Referring to FIGS. 6A and 4A a portion of the component 10 passes through an aperture A3 in the jig 20. The portion of the of the component 10 may take the form of a post or peg and may form part of a mounting bracket for securing the component 10 to another member of the controller input apparatus (not shown).

The jig 20 is removably mountable to a tray 40, the tray comprises at least one mounting location 46. The illustrated embodiment comprises three mounting locations 46, each is capable of receiving a respective jig 20. Each mounting location may comprise one or more orifices or openings 48 for receiving a portion of the component 10 or in alternative embodiments a portion of the jig 20. The portion of the component 10, post 23, may be employ to align or register the component 10 with the jig 20 and with the tray 40. The portion of the component 10, post 23, may serve to align the jig 20 with the tray 40. In this way the position of the component 10 is accurately controlled with respect to the tray 40, this facilitates accurate alignment of a sublimation printing sheet (not shown) with respect to the component such that the ink is printed upon the desired location of the print surfaces PS in the desired orientation.

The base of the jig 20 may be recessed or hollowed for receiving a portion of the tray 40 in the mounting location 46.

The mounting locations 46 may comprise one or more cut-outs, notches or recess to facilitate removal of the jig 20 from the tray 40. An operator may insert a tool or finger into the cut-out to engage the jig 20. The cut-out may provide access to an edge of the jig 20 to lever the jig 20 away from the tray 40. In alternative embodiments, an aperture may be provided in the tray 40, within the mounting location 46, a tool may be inserted from below, passing through the tray 40, to engage the base of the jig 20 and lift the jig 20 above the tray 40.

The tray 40 comprises an upper surface 42, openings 42 in the upper surface provide conduits for creating a vacuum to bring the sublimation printing sheet into contact with the components 10. The upper surface 42 may be contoured or non-planar in shape to control or facilitate engagement of the sheet with the component 10 and avoid gaps or creases in the sheet which could lead to imperfections in the ink transfer.

The mounting locations 46 may be arranged such that the jig 20 is at least partially disposed below the upper surface 42 of the tray 40, the jig 20 may sit within a recess. In this way the print surfaces PS of the component 10 are disposed proximate the upper surface 42 of the tray 40.

The upper surface of the tray 40 may be generally dish shaped, that is to say concave when viewed from above. In this way the jigs 20 and the components 10 may be disposed below the upper periphery of the tray 40. The tray 40 may have depth equal to or greater than the height of the combination of the jig 20 and the component 10.

In use the tray 40 is inserted into a printer device in the form of a vacuum heat press or oven, a sublimation printing sheet is applied to the tray 40, prior to insertion, over the upper surface and the components 10 to be printed upon.

The tray 40 along with the jigs 20, components 10, and sublimation printing sheet are heated in the printer device, the vacuum ensures the sublimation printing sheet is tightly wrapped about the components 10. The tray 40 along with the jigs 20, components 10, and sublimation printing sheet are heated such that the dye or ink on the sublimation printing sheet sublimates from solid to gas and enters pores in the component substrate so as to transfer the design from the sublimation printing sheet to the components 10.

Once the transfer is complete the tray 40 is removed from the printer device, and the components 10 are removed from the tray 40 whilst still mounted to the jig 20. The vacant mounting locations in the tray 40 may be loaded with a further set of unprinted components 10 mounted to respective jigs 20. A new sublimation printing sheet is applied to the tray 40 and is reinserted into the printer device; the tray 40 may not substantially cool down between print jobs thus saving energy and time compared to heating the tray 40 from cold for each print job.

The printed components 10 removed from the tray 40, along with their respective jigs 20, are allowed to cool separate from the tray 40. The components 10 are retained in shape by the jigs 20 during the heating and cooling process. Once sufficiently cool the printed components 10 are removed from their respective jigs 20, the jigs 20 may be reused with further components 10.

The present disclosure provides an apparatus for use in a sublimation print device, the apparatus comprises a tray 40 having at least one mounting location 46 for receiving a jig 20. The jig 20 is configured to form a rigid frame or body 22 for an article 10. The jig 20 is formed from a material capable of withstanding the temperature of a sublimation print process without substantial deformation or distortion. The jig 20 mates to the article 10 so as to retain the shape of the article 10 during the sublimation print process.

The jig 20 is removably mountable to the mounting location 46 of the tray 40.

The jig 20 may be formed from a thermally conductive material.

The jig 20 may comprise at least one first registration device A3 for engagement with at least one second registration device 23 provided by the article 10 such that the article 10 is aligned with respect to the jig 40. The tray 40 may comprises at least one third registration device 48 for engagement with the at least one second registration device 23. Optionally, the at least one third registration device 48 may engage a registration device provided by the jig 20.

The present disclosure also provides a method of sublimation printing an article 10 comprising:
mounting the article 10 to a jig 20;
mounting the combination of the jig 20 and the article 10 to a tray 40;
applying a sublimation print sheet to the tray 40 over the jig 20 and the article 10;
inserting the tray 40 into a print device;
heating the sublimation print sheet, tray 40, jig 20 and article 10 sufficient to sublimate ink on the sublimation print sheet;
transferring ink on the sublimation print sheet to the article 10;
removing the tray 40 from the print device;
removing the combination of the article 10 and the jig 20 from the tray 40;
cooling the article 10 and the jig 20; and
removing the article 10 from the jig 20.

The method may further comprise aligning the article 10 with the jig 20 and aligning the jig 20 and/or article 10 with respect to the tray 40.

It can be appreciated that various changes may be made within the scope of the present invention. For example, the size and shape of the components may be adjusted to accommodate controllers of differing size or shape. Whilst in the foregoing embodiments the component forms a front panel of a game controller it will be appreciated that the apparatus may be modified to be employed with alternative products such as (but not limited to): computer game or console peripherals for example: mice or tracker balls, keyboards, headsets or headphones; to cases or housings for mobile devices, phones, tablet computers; desktop computer or video game console cases or other suitable products.

It will be recognized that as used herein, directional references such as “top”, “bottom”, “front”, “back”, “end”, “side”, “inner”, “outer”, “upper” and “lower” do not limit the respective features to such orientation, but merely serve to distinguish these features from one another.

What is claimed is:

1. A jig for use in a sublimation print device comprising a rigid frame or body for receiving an article, the jig being formed from a thermally conductive material capable of withstanding the temperature of a sublimation print process without substantial deformation or distortion, wherein the jig is configured to mate with an article so as to retain the shape of the article during the sublimation print process and wherein the jig is removably mountable to a mounting location of the tray.

2. The jig of claim 1, wherein the jig comprises at least one first registration device for engagement with the article.

3. The jig of claim 1, wherein the jig comprises at least one detachable member.

4. The jig of claim 1, wherein the at least one detachable member is configured to close at least a portion of an opening in the article.

5. The jig of claim 1, wherein the jig comprises receiving locations for mounting two or more component parts of an article, the jig holding the two or more component parts in the same respective positions as the article which they form.

6. A tray for use in a sublimation print device, the tray comprising at least one mounting location for receiving a jig, the jig being configured to be detachable mountable to the tray, the at least one mounting location being recessed in an upper surface of the tray.

7. The tray of claim 6, wherein the tray comprises a concave upper surface, and the mounting locations are arranged such that the jig and article, when mounted thereto, are disposed below an upper periphery of the tray.

8. The tray of claim 6, wherein the tray comprises at least one registration device for engagement with the article.

9. An apparatus for use in a sublimation print device, the apparatus comprising a tray having at least one mounting location for receiving a jig, the jig being configured to form a rigid frame or body for an article, wherein the jig is formed from a material capable of withstanding the temperature of a sublimation print process without substantial deformation or distortion, the jig is configured to mate with the article so as to retain the shape of the article during the sublimation print process and wherein the jig is removably mountable to the mounting location of the tray.

10. The apparatus of claim 9, wherein the jig comprises at least one first registration device for engagement with at least one second registration device provided by the article.

11. The apparatus of claim 10, wherein the tray comprises at least one third registration device for engagement with the at least one second registration device provided by the article.

12. The apparatus of claim 9, wherein the tray comprises at least one alignment device for engagement with an alignment device provided by the jig.

13. The apparatus of claim 9, wherein the tray comprises a release device for facilitating separation of the jig from the tray.

14. The apparatus of claim 9, wherein the release device comprises a cut-out in at least one of the tray and the jig for insertion of a release tool.

15. The apparatus of claim 9, wherein the mounting location comprises a recess in an upper surface of the tray for receiving at least a portion of the jig.

16. The apparatus of claim 9, wherein the jig comprises at least one detachable member.

17. The apparatus of claim 9, wherein the at least one detachable member is configured to close at least a portion of an opening in the article.

18. The apparatus of claim 9, wherein the jig comprises receiving locations for mounting two or more component parts of an article, the jig holding the two or more component parts in the same respective positions as the article which they form.

19. A method of sublimation printing an article comprising:
mounting the article to a jig;
mounting the combination of the jig and the article to a tray;
applying a sublimation print sheet to the tray over the jig and the article;
inserting the tray into a print device;
heating the sublimation print sheet, tray, jig and article sufficient to sublimate ink on the sublimation print sheet;
transferring ink on the sublimation print sheet to the article;
removing the tray from the print device;
removing the combination of the article and the jig from the tray;
cooling the article and the jig; and
removing the article from the jig.

20. The method of claim 19, wherein the method further comprises aligning the article with the jig and aligning the jig and/or article with respect to the tray.
